(19) United States
(12) Patent Application Publication
(10) Pub. No.: US 2005/0211180 A1
(43) Pub. Date: Sep. 29, 2005

(54) Aquarium tank

(76) Inventor: Steven J. Grant, Edwardsville, IL (US)

Correspondence Address: Steven Grant;c/o S and E Innovations, Inc., 2704 Falcon Crest, Edwardsville, IL, 62025, US

(21) Appl. No.: 11/090,669

(22) Filed: Mar. 25, 2005

Related U.S. Application Data
(60) Provisional application No. 60/556,700, filed on Mar. 29, 2004.

(51) Int. Cl. A01K 63/00

(52) U.S. Cl. 119/253

(57) ABSTRACT

This invention relates to a unique ornamental aquarium design that incorporates a cylinder shaped unit, a base, and a top section. The base's lighting unit will project upward a wide variety of colored lights, including white light, into the tank. The unit will plug into a standard outlet. A mechanism is included on the base to allow for the lights to be rotated either automatically or one color at a time. The housing unit or tank has a broad opening for inserting fish, decorative objects or an air filtration device. The top is designed to allow for an air filtration device to be inserted through the top and into the tank.

### BACKGROUND AND SUMMARY OF THE INVENTION

The invention relates to aquariums, and more particularly to a new way of housing fish in a unique tank that allows for various colored lights to be displayed from a base. This base will have a mechanism that will allow a user to rotate colors automatically or one at a time. A unique top will allow for an air filtration device to be connected and inserted into the top so that it will lead to the aquarium tank.

### BRIEF DESCRIPTION OF THE DRAWINGS

FIG. 1. is a view of the aquarium tank that consists of the base (1), housing unit for the fish (2), and the top (3).

FIG. 2. is a view of the housing unit for the fish and the base with the mechanism for rotating the colored lights. The top is removed to give the overall look of the housing unit.

### DETAILED DESCRIPTION OF THE INVENTION AND DRAWINGS

This invention provides a very unique way to display fish in a new type of ornamental aquarium. One key advantage of this product is that it offers a variety of lighting options when compared to traditional aquarium tanks. This includes a broad array of colored lighting options for which white light is an option as well. A mechanism for rotating the lights automatically or one at a time is included.

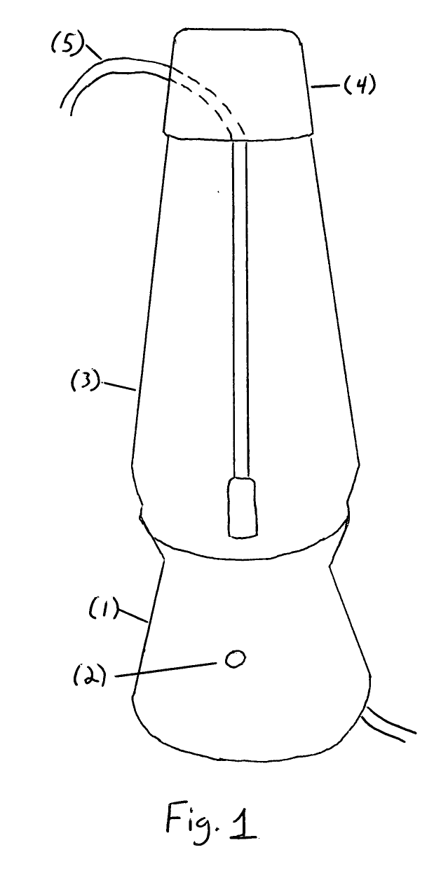

FIG. 1. shows the look of the aquarium tank when assembled. This includes a base unit (1), that supports the aquarium tank and has the lighting unit installed inside the base. It also has a mechanism that is located on the base for rotating the colored or white lighting options (2). This mechanism offers the user the options of either having the broad array of colored lights be rotated automatically or one at a time. The housing unit for the fish is marked (3) and will hold the fish and water. It is shaped as a cylinder. It also has a top section (4) which can be removed. This top serves as a way to not only enclose the housing unit or tank, but connected to the top is the ability for an air hose (5) to be installed and this will allow the hose to go directly into the housing unit through the top section.

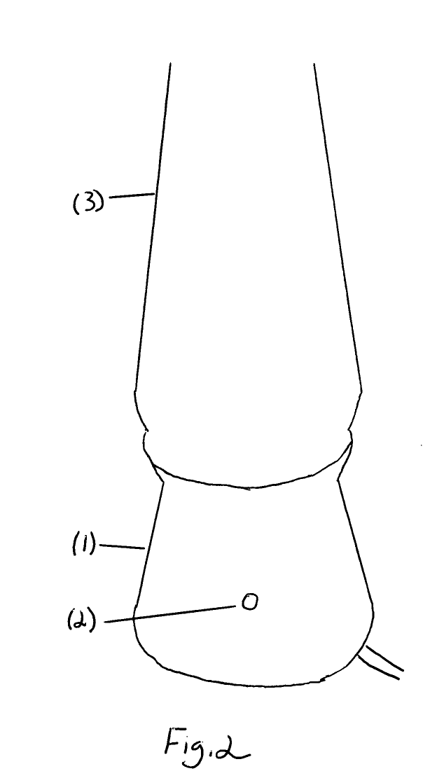

FIG. 2. shows the base unit (1) and the mechanism for rotating the colored and white lights (2) with the housing unit for the fish and water (3). The top is removed in this picture to show the broad opening for which the fish and also any decorative objects and the air filtration device can be placed within the said aquarium tank.

1. An ornamental aquarium of cylindrical shape comprising:
(a) a base that consists of a lighting unit that transmits a broad array of colored lights, including white, upward into the said aquarium tank with a mechanism that allows the lights to be rotated either automatically or one at a time,
(b) a cylindrical shape unit to house fish with a broad top opening that will be placed on the said base,
(c) a cap that will reside on top of the said cylindrical shape unit with an opening for inserting an air filtration device.
